(19) United States
(12) Patent Application Publication
(10) Pub. No.: US 2017/0273300 A1
(43) Pub. Date: Sep. 28, 2017

(54) ANTIMICROBIAL COVER

(71) Applicant: Tessara (Pty) Ltd, Cape Town (ZA)

(72) Inventor: Alwyn Jacobus Van Jaarsveld, Bellville (ZA)

(21) Appl. No.: 15/529,352

(22) PCT Filed: Nov. 16, 2015
(86) PCT No.: PCT/IB2015/058832

§ 371 Date: May 24, 2017

(30) Foreign Application Priority Data
Nov. 27, 2014 (GB) 1421038.9

(51) Int. Cl. A01N 25/34; B65D 81/28; B65D 85/34; B65D 21/02; A01N 59/02; B65B 7/28; B65D 81/26; A23B 7/152; A23L 3/3445; B65B 25/04; B65D 77/20

(52) U.S. Cl. CPC A01N 25/34; B65B 25/041; B65D 81/28; B65D 85/34; B65D 21/0215; B65D 77/20; B65B 7/28; B65D 81/263; A23B 7/152; A23L 3/3445; A01N 59/02; A23V 2002/00

(57) ABSTRACT

This invention relates to an antimicrobial cover comprising or consisting of an antimicrobial agent-generating article for use with a container for transporting or storage of fruit and a container comprising the antimicrobial of the invention. The invention further relates to a method of preventing or inhibiting the growth of microorganisms, particularly fungal organisms, in packaged fruit comprising the use of the antimicrobial of the invention.

### BACKGROUND OF THE INVENTION

This invention relates to an antimicrobial cover comprising or consisting of an antimicrobial agent-generating article for use with a container for transporting or storage of fruit and a container comprising the antimicrobial cover of the invention. The invention further relates to a method of preventing or inhibiting the growth of microorganisms, particularly fungal organisms, in packaged fruit comprising the use of the antimicrobial cover of the invention.

The fruit industry is a global industry requiring transportation of fruit across the world to consumers who demand access to a wide variety of choice regardless of the season or climate required for the fruit to be grown and a high quality of product. The time to transport such fruit may be substantial, and may be in excess of a month.

In particular, in the case of fruit with high moisture such as grapes, berries, melons and the like, moisture within the fruit is released, that can result in a humid environment within the transport container. This, together with potential increased temperature during transport, is an ideal breeding ground for microorganisms, in particular funguses including Botrytis and molds. Various methods exist for the prevention or inhibition of microbial growth including fungal growth on fruit, particularly grapes. One such method is in the form of SO₂ or CO₂ fumigation into the packaging, such as that described in U.S. Pat. No. 6,357,207 or Japanese patent number JPH08183608. However, such systems require that the packaging is a sealed environment for the fumigant to be effective and so opening of the containers during transit is problematic and would require re-fumigation.

Another mechanism is by means of a single or dual-release SO₂ generating article such as that described in U.S. Pat. Nos. 7,045,182 or 5,106,596. The SO₂ generating articles operate by being in contact with the fruit however, for example, SO₂ generating sheets or pads may be laid on top of the fruit which is contained in a bag, or may be used to line the container in which the fruit is transported or stored. Alternatively, the bag itself may be formed from an SO₂ generating sheet. However, these sheets that operate in contact with the fruit are problematic in that they may cause bleaching of the fruit. Furthermore, a significant amount of material is required in the case of SO₂ generating sheets that are formed as bags or container liners. It is also labour intensive to package the fruit using such mechanisms. A simpler, more cost effective alternative would be useful.

Furthermore, certain fruit releases compounds such as ethylene that promote ripening which can be problematic, in particular for fruit such as bananas apples, pears and kiwi fruit. An excess in ethylene may cause the fruit product to become spotted, soft, or mealy, which is unappealing for consumers. Similarly, respiration of fruit continues after harvesting and can result in early ripening of fruit during transport. Various methods are known that mitigate the ripening and ultimately spoiling of fruit during transit and while in storage.

However, there is no single solution that presently exists that is able to address all the problems associated with long term transport and storage of fruit.

Various containers exist for the transport and/or storage of fruit, including plastic, cardboard, wax-coated, polystyrene foam products and the like. When bulk shipping is required, such containers are typically stacked on top of each other in a pallet. An article that addresses all of the problems associated with long term transport and storage of fruit, is less labour intensive to install and use than the traditional means and that can be used for any type of container would be greatly beneficial.

### SUMMARY OF THE INVENTION

According to a first embodiment of the invention, there is provided an antimicrobial cover comprising or consisting of an antimicrobial agent-generating article for use with a container for transporting or storage of fruit.

The antimicrobial agent-generating article may be a sulphur dioxide (SO₂) generating article. The SO₂ generating article is preferably a dual-release SO₂ generating article. For example, the SO₂ generating article may be as claimed in any of the published patents ZA8900691, ZA9507170, U.S. Pat. No. 5,106,596 or U.S. Pat. No. 7,045,182 (the contents of all of which are incorporated herein by reference).

The antimicrobial cover and/or antimicrobial agent-generating article may further comprise any one or more of an ethylene scrubber, or a carbon dioxide (CO₂) generating article.

The ethylene scrubber may be potassium permanganate, although many ethylene scrubbers are known to those skilled in the art and may be used.

The antimicrobial cover may be dimensioned to the desired size and shape of the container onto which it is to be applied. For example, the container may be any moisture resistant container including, but not limited to, plastic, wax coated, wax paper lined, or polystyrene foam containers and the like.

The antimicrobial cover may be adapted to fit a stackable container used for bulk shipment. Alternatively, the antimicrobial cover may be adapted to fit a container for small-scale transport or storage.

The antimicrobial cover preferably comprises an uninterrupted sheet of material, apart from optionally comprising a plurality of slits at the periphery of the antimicrobial cover through which interlocking lugs or stacking feet between containers may operably fit.

The antimicrobial cover may be opaque. Alternatively, it may be transparent thereby to allow the fruit within the container to be visible.

The antimicrobial cover may be comprised of a plastic material. In particular, the antimicrobial cover may be comprised of a resilient or elastic plastic material. The antimicrobial agent-generating article may be affixed to an operably inwardly facing surface of the antimicrobial cover. Alternatively, the antimicrobial cover may be integrally formed with or may consist of the antimicrobial agent-generating article.

According to a further aspect of the invention, there is provided a container comprising a antimicrobial cover according to the invention. Preferably, the container is adapted for transport or storage of fruit.

For example, the container may comprise a plurality of apertures in the horizontal plane for air flow and/or cooling. Preferably, the base of the container is a solid base.

The container may be any moisture resistant container including, but not limited to, plastic, wax coated, wax paper lined, or polystyrene foam containers and the like.

The container may be a stackable container used for bulk shipment. Alternatively, the container may be for small-scale transport or storage.

The fruit may be any fruit, for example, but not limited to, grapes, berries (including but not limited to strawberries, blackberries, cranberries, blueberries, raspberries and the like), melons, kiwi fruit, bananas, apples, pears and the like.

According to a further aspect of the invention, there is provided a method of preventing or inhibiting the growth of microorganisms, particularly fungal organisms, in packaged fruit comprising the use of the antimicrobial cover of the invention. For example, method may be for prevention or inhibition of the growth of Botrytis.

The method may comprise the steps of:
(i) providing an antimicrobial cover according to the invention, comprising an antimicrobial agent-generating article, the antimicrobial cover adapted to fit over an open end of a container for transporting or storage of fruit;
(ii) providing a container suitable for transporting or storage of fruit;
(iii) packaging and or positioning the fruit in the container;
(iv) slipping the antimicrobial cover over the open end of the packed container such that the antimicrobial agent-generating article is adjacent to, but not in direct contact with, the fruit in the container.

The antimicrobial cover may be maintained in place by tension in the case where the antimicrobial cover is comprised of an elastic or resilient plastic material. Alternatively, the antimicrobial cover may comprise a plurality of slits at the periphery of the antimicrobial cover through which interlocking lugs or stacking feet between containers operably fit, also thereby maintaining the antimicrobial cover in place. Further alternatively, the antimicrobial cover may comprise an adhesive material adapted to adhere the periphery of the antimicrobial cover to the receiving end of the container. For example, the adhesive material may comprise a plurality of sticky pads.

The antimicrobial cover may further comprise any one or more of an ethylene scrubber, or a carbon dioxide (CO₂) generating article on one surface of the antimicrobial cover and in step (iv) the antimicrobial cover is slipped over the open end of the packed container such that the antimicrobial agent-generating article and the ethylene scrubber, or a carbon dioxide (CO₂) generating article or any combination of these is adjacent to, but not in direct contact with, the fruit in the container.

The method may comprise a further step where the antimicrobial cover comprises a plurality of slits at the periphery of the antimicrobial cover through which interlocking lugs or stacking feet between containers may operably fit, of positioning the slits over the interlocking lugs or stacking feet of the container over which it is slipped.

Stackable containers comprising the antimicrobial covers may then be stacked on top of each other.

The fruit may be any fruit, for example, but not limited to, grapes, berries (including but not limited to strawberries, blackberries, cranberries, blueberries, raspberries and the like), melons, kiwi fruit, bananas, apples, pears and the like.

According to a further aspect of the invention, there is provided a method of making an antimicrobial cover according to the invention comprising processing a sheet of antimicrobial cover material comprising an antimicrobial agent-generating article and optionally an ethylene scrubber, or a CO₂ generating article, or both, to the dimension of the particular container size selected, such that the antimicrobial cover operably fits over a receiving end of the container, for example with a margin of overhang of between about 20-80 mm.

The antimicrobial agent-generating article and optionally the ethylene scrubber, or CO₂ generating article, or both may be integrally formed with the sheet of antimicrobial cover material.

Alternatively, the method may comprise the following steps:
(i) separately processing sheets comprising the antimicrobial agent-generating article and optionally the ethylene scrubber, or CO₂ generating article, or both to an appropriate dimension as determined by the dimensions of a receiving end of the selected container such that the antimicrobial agent-generating article and optionally the ethylene scrubber, or CO₂ generating article, or both operably cover a surface of about 60 to 100% of the surface area of the antimicrobial cover, preferably about 80% of the antimicrobial cover;
(ii) affixing the processed antimicrobial agent-generating article and optionally the ethylene scrubber, or CO₂ generating article, or both to a sheet of antimicrobial cover material; and
(iii) processing the sheet of antimicrobial cover material of step (ii) to the dimension of the particular container size selected, such that the antimicrobial cover operably fits over a receiving end of the container with a margin of overhang of between about 20 to about 80 mm.

Processing may be performed by cutting the sheets to the desired width and length. Any cutting technique known to those skilled in the art that utilizes a sharp blade and does not produce frayed edges, product delamination, crystallization, melting, activation, discolouration or contamination as an effect during or after the process may be used.

In particular, the sheet of antimicrobial cover material or the sheet comprising the antimicrobial agent-generating article may be a dual-release SO₂ generating material as claimed in the published patents ZA8900691, ZA9507170, U.S. Pat. No. 5,106,596 and U.S. Pat. No. 7,045,182.

The step of affixing may be performed either by an adhesive means or a mechanical means. For example, the step of affixing may be performed by means of glue or staples.

### BRIEF DESCRIPTION OF THE DRAWINGS

FIG. 1 shows a schematic representation of a antimicrobial cover according to the invention in use, situated over the receiving end of a container for transporting and/or storage of fruit.

### DETAILED DESCRIPTION OF THE INVENTION

The current invention provides an antimicrobial cover comprising or consisting of an antimicrobial agent-generating article for use with a container for transporting or storage of fruit and a container comprising the antimicrobial cover of the invention. The invention further relates to a method of preventing or inhibiting the growth of microorganisms, particularly fungal organisms, in packaged fruit comprising the use of the antimicrobial cover of the invention.

As used herein, “antimicrobial cover” means a fitted cover for a container for transporting and/or storage of fruit that may be easily slipped on or off a receiving end of the container.

As used herein “container” means any type of container for holding fruit, including but not limited to cartons, boxes, punnets, cases and the like.

Current methods of preserving fruit when in transit, in particular over large distances of for extended time periods are labour intensive. Furthermore, no single solution exists that addresses various problems associated with long distance travel and extended shipping periods such as over-ripening, premature ripening and spoiling of fruit due to infection by pathogens.

The applicant sought to develop a product that could be used with fruit transport and/or storage containers to preserve the fruit from spoiling and/or over-ripening. The applicant determined that surprisingly, it was possible to preserve the fruit transported in containers by means of a simple antimicrobial cover for the container comprising an antimicrobial agent-generating article.

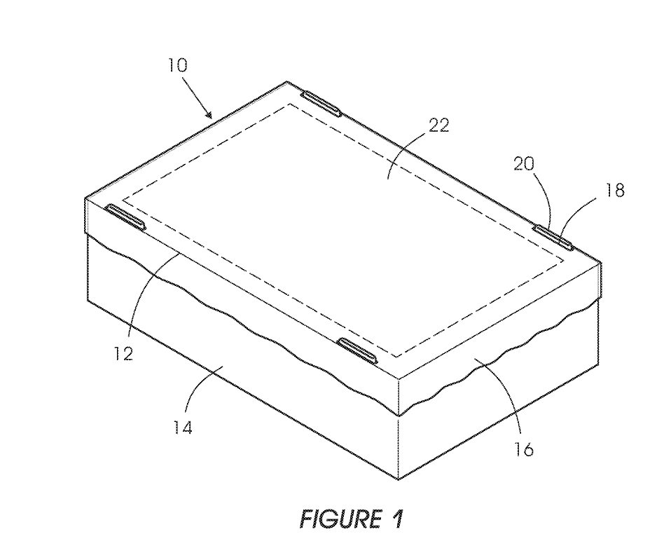

As illustrated in FIG. 1, the product developed is a simple antimicrobial cover (10) comprising an antimicrobial agent-generating article and optionally an ethylene scrubber, or CO₂ generating article, or both, dimensioned to fit over a receiving end (12) of a fruit container (14) such that the edges (16) of the antimicrobial cover overhang the receiving end of the container sufficiently to prevent easy dislodgement of the antimicrobial cover. Optionally, the antimicrobial cover may further comprise slits (18) positioned to receive the stacking feet or lugs (20) of the container where the containers are designed to stack one on top of the other.

The antimicrobial agent-generating article (22) and optionally an ethylene scrubber, or CO₂ generating article, or both is typically affixed (for example, by means of glue or staples, or other means known to those skilled in the art) to the operably inwardly facing surface of the antimicrobial cover adjacent to, but not in direct contact with the fruit.

The antimicrobial cover is simple to use, in that packages of the antimicrobial covers cut to the desired size of the customer, depending on the dimension of the containers to be covered are provided to the customer. The customer packages the fruit into the containers according to their standard practice. Next, one of the antimicrobial covers is selected and slipped over the open receiving end (12) of the container of fruit (14) such that the antimicrobial agent-generating article (22) and optionally an ethylene scrubber, or CO₂ generating article, or both face inwardly towards and adjacent the fruit, but not in direct contact thereto.

The antimicrobial covers can be sized to any shape of container by cutting them to the desired size. They can also be fitted onto any typical fruit container.

Should the customer desire it, the antimicrobial cover may be transparent so that the fruit is visible through the antimicrobial cover.

The product is versatile and may merely include the antimicrobial agent-generating article (22), or alternatively may comprise any one or both of an ethylene scrubber, or CO₂ generating article as well.

Although other antimicrobial agent-generating articles known to those skilled in the art may be used, typically, the antimicrobial agent-generating article (22) is a dual release SO₂ generating sheet as claimed in the published patents ZA8900691, ZA9507170, U.S. Pat. No. 5,106,596 and U.S. Pat. No. 7,045,182 which is then processed either to be affixed to the antimicrobial cover (10) or to the desired size for fitting directly onto the container (14), including an overhang of about 20 to about 80 mm 20-80 on each edge (16). When affixing the antimicrobial agent-generating article (22) to the antimicrobial cover material, it is positioned approximately centrally relative to the antimicrobial cover (10) when processed to fit over the receiving end (12) of the container (14). The antimicrobial agent-generating article and optionally the ethylene scrubber, or CO₂ generating article, or both typically operably cover a surface of 80% of the surface area of the antimicrobial cover.

1. A container for transport or storage of fruit having a solid base, four sides, and an open end comprising: (i) a plurality of apertures in the horizontal plane of the container for air flow, cooling or both and (ii) an antimicrobial cover of uninterrupted material adapted to fit over the open end of the container comprising or consisting of an antimicrobial agent-generating article.

2. The container according to claim 1, wherein the antimicrobial agent-generating article is a sulphur dioxide (SO₂) generating article.

3. The container according to claim 2, wherein the SO₂ generating article is a dual-release SO₂ generating article.

4. The container according to claim 1, wherein the antimicrobial cover or antimicrobial agent-generating article or both further comprise an ethylene scrubber, or a carbon dioxide (CO₂) generating, article, or both.

5. The container according to claim 1 which is comprised of a moisture resistant material selected from the group consisting of plastic, wax coated, wax paper lined, and polystyrene foam.

6. The container according to claim 1 which is a stackable container comprising interlocking lugs or stacking feet.

7. (canceled)

8. The container according to claim 1 wherein the antimicrobial cover is transparent.

9. The container according to claim 1, wherein the antimicrobial agent-generating article is affixed to an operably inwardly facing surface of the antimicrobial cover.

10. The container according to claim 1, wherein the antimicrobial cover is integrally formed with or consists of the antimicrobial agent-generating article.

11. (canceled)

12. A method of preventing or inhibiting the growth of microorganisms in packaged fruit comprising the use of the container according to claim 1.

13. The method according to claim 12, for preventing or inhibiting the growth of Botrytis.

14. The method according to claim 12, comprising the steps of:
(i) providing the container according to claim 1;
(ii) packaging and/or positioning the fruit in the container; and
(iii) slipping the antimicrobial cover over the open end of the packed container such that the antimicrobial agent-generating article is adjacent to, but not in direct contact with, the fruit in the container.

15. The method according to claim 12, wherein the fruit comprises grapes, berries comprising strawberries, blackberries, cranberries, blueberries, and raspberries, melons, kiwi fruit, bananas, apples or pears.

16. A method of making an antimicrobial cover for use with a container according to claim 1, comprising processing a sheet of antimicrobial cover material comprising an antimicrobial agent-generating article, an ethylene scrubber, or a CO₂ generating article, or any combination thereof, to the dimension of the open end of the container, such that the antimicrobial cover operably fits over the open end of the container, with a margin of overhang of between about 20-80 mm.

17. The method according to claim 16, wherein the antimicrobial agent-generating article, the ethylene scrubber, or CO₂ generating article, or any combination thereof are integrally formed with the sheet of antimicrobial cover material.

18. The method according to claim 16, comprising the following steps:
(i) processing the antimicrobial agent-generating article such that the antimicrobial agent-generating article operably covers a surface of about 60 to 100% of the surface area of the antimicrobial cover;
(ii) affixing the processed antimicrobial agent-generating article to the sheet of antimicrobial cover material; and
(iii) processing the sheet of antimicrobial cover material, of step (ii) to the dimension of the open end of the container, such that the antimicrobial cover operably fits over the open end of the container with a margin of overhang of between about 20 to about 80 mm.

19. The method according to claim 18, wherein the antimicrobial agent-generating article operably covers a surface of about 80% of the surface area of the antimicrobial cover.

20. The method according to claim 16, wherein the sheet of antimicrobial cover material or the sheet comprising the antimicrobial agent-generating article is a dual-release SO₂ generating material.

21.-22. (canceled)

23. The container according to claim 6, wherein the antimicrobial cover comprises a plurality of slits at the periphery of the antimicrobial cover through which interlocking lugs or stacking feet between containers operably fit.

24. The method according to claim 12, wherein the microorganisms are fungal organisms.

25. A set of articles comprising (i) a container for transport or storage of fruit having a solid base and four sides, a plurality of apertures in the horizontal plane of the container for air flow, cooling or both; and (ii) an antimicrobial cover of uninterrupted material comprising or consisting of an antimicrobial agent-generating article.
